(19) United States
(12) Patent Application Publication
(10) Pub. No.: US 2026/0369455 A1
(43) Pub. Date: Nov. 19, 2026

(54) TRANSFORMER AND POWER SUPPLY DEVICE USING SAME

(71) Applicant: LG INNOTEK CO., LTD., Seoul (KR)

(72) Inventors: Sue Kyung OH, Seoul (KR); Bi Yi KIM, Seoul (KR); Yong Ha CHOI, Seoul (KR)

(21) Appl. No.: 19/143,839

(22) PCT Filed: Dec. 26, 2023
(86) PCT No.: PCT/KR2023/021618

§ 371 Date: Jun. 26, 2025

(30) Foreign Application Priority Data
Dec. 27, 2022 (KR) 10-2022-0185821

(51) Int. Cl. H01F 27/255; H01F 27/06; H01F 27/32; H01F 30/10; H01F 41/02

(52) U.S. Cl. CPC H01F 27/255; H01F 27/325; H01F 30/10; H01F 41/0246; H01F 27/06

(57) ABSTRACT

The present invention relates to a transformer and a power supply device using same, the transformer being capable of reducing the occurrence of defects due to a core shrinkage phenomenon during a curing process of a bonding liquid. The transformer according to the present invention may comprise: a core part including an upper core and a lower core which are coupled to face each other; and a bobbin which is at least partially disposed between the upper core and the lower core, wherein the upper core and the lower core comprises: a body part in the form of a flat plate; and a plurality of legs formed by protrusion parts protruding from the body part in a thickness direction and extending along one axial direction, and the protrusion parts form a predetermined proportional relationship with the body part and have different thicknesses, so that the thicknesses of the protrusion parts and rear surfaces of the upper core and the lower core can be designed at an optimal ratio, and thus the occurrence of a warpage phenomenon of the cores can be inhibited during a curing process after bonding and during operation.

### TECHNICAL FIELD

The present disclosure relates to a transformer and a power supply unit including the same, and more particularly, to a transformer capable of reducing defects caused by shrinkage of a core during a curing process of a bonding agent and a power supply unit including the same.

### BACKGROUND ART

Various coil components, such as transformers or line filters, are mounted in power supply units of electronic devices.

A transformer may be included in an electronic device for various purposes. For example, a transformer may be used to perform an energy transfer function of delivering energy from one circuit to another circuit. In addition, a transformer may also be used to perform a voltage conversion function, such as stepping up or stepping down voltage. Further, because a transformer provides only inductive coupling between a primary winding and a secondary winding without directly forming any DC path, the transformer may also be used to block direct current while passing alternating current or to electrically isolate two circuits.

Unlike general transformers, a slim transformer is required to have a narrow center leg of a core unit and a reduced thickness of a flat plate-shaped body in order to secure a physical cross-sectional area for windings. As the thickness of the flat plate-shaped body, that is, the rear surface of the transformer, decreases, heat generation tends to occur from the rear surface during operation of a circuit. In addition, even if the temperature resulting from heat generated from a temporarily assembled structure (without a bonding agent) is below the reference specification of 65 °C, shrinkage of the core occurs during a curing process of a bonding agent when the structure is fully assembled (with the bonding agent), as shown in FIG. 1.

If shrinkage of the heat-generating core occurs during a curing process of the bonding agent, a thickness defect may occur in which a gap is formed between an upper core 10 and a lower core 20, as shown in FIG. 1. If the thickness of an outer leg of the assembled transformer is greater than the thickness of a center leg by 100 μm or more, the transformer may be determined to have a thickness defect. Such a thickness defect may cause non-ideal heat generation. Therefore, there is a demand for development of a core for a slim transformer having an optimal rear surface thickness.

### DISCLOSURE

### Technical Problem

An aspect of the present disclosure is to provide a transformer capable of reducing defects caused by shrinkage of a core during a curing process of a bonding agent and a power supply unit using the same.

Another aspect of the present disclosure is to provide a transformer including a core having an optimal rear surface thickness and a power supply unit using the same.

### Technical Solution

A transformer according to the present disclosure for accomplishing the above aspects includes a core unit including an upper core and a lower core disposed to face each other and configured to be combined with each other and a bobbin at least partially disposed between the upper core and the lower core, wherein each of the upper core and the lower core includes a flat plate-shaped body portion and a plurality of legs, each of which is formed by a protruding portion protruding in a thickness direction from the body portion and extending in one axial direction, and the protruding portion has a thickness different from the thickness of the body portion.

In the transformer according to an embodiment of the present disclosure, the thickness of the protruding portion may be equal to or less than 0.99 times the thickness of the body portion.

In the transformer according to an embodiment of the present disclosure, the thickness of the body portion may be equal to or greater than 25% of the overall thickness of the transformer.

In the transformer according to an embodiment of the present disclosure, the overall thickness of the transformer may be equal to or less than 10.4 mm.

In the transformer according to an embodiment of the present disclosure, the thickness of the protruding portion may be equal to or greater than 1.01 times the thickness of the body portion.

In the transformer according to an embodiment of the present disclosure, the thickness of the body portion may be equal to or greater than 18% and less than 25% of the overall thickness of the transformer.

In the transformer according to an embodiment of the present disclosure, the overall thickness of the transformer may be greater than 10.4 mm.

In the transformer according to an embodiment of the present disclosure, the plurality of legs may include two outer legs disposed apart from each other at respective longitudinal ends of the body portion and a center leg disposed between the two outer legs.

In the upper core and the lower core of the transformer according to an embodiment of the present disclosure, the outer legs corresponding to each other may be disposed to face each other, and the center legs corresponding to each other may be disposed to face each other. A gap of a predetermined distance may be formed between at least one pair among the opposing pairs of outer legs and the opposing pair of center legs.

In the transformer according to an embodiment of the present disclosure, the core unit may include a magnetic material.

### Advantageous Effects

The transformer and the power supply unit using the same according to the present disclosure may ensure that a core having an optimal thickness satisfies design criteria, thereby preventing warpage of the core after bonding.

### DESCRIPTION OF DRAWINGS

FIG. 1 is a view showing an exemplary thickness defect occurring during a curing process of a bonding agent in a general slim transformer.

FIG. 2A is an exploded perspective view showing an example of the configuration of a slim transformer.

FIG. 2B is a perspective view of the slim transformer shown in FIG. 2A.

FIG. 3 is a plan view of an upper core of the transformer according to the present disclosure.

FIG. 4 is a plan view of the upper core shown in FIG. 3.

FIG. 5 is a graph showing heat generation of the core according to the thickness of a rear surface during operation of the transformer.

FIG. 6 is a view showing an exemplary substrate on which the transformer is mounted.

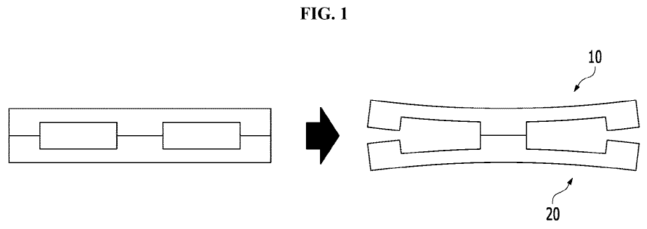

### BEST MODE

Various exemplary embodiments will now be described more fully with reference to the accompanying drawings, in which only some exemplary embodiments are shown. Specific structural and functional details disclosed herein are merely representative for the purpose of describing exemplary embodiments. The present disclosure, however, may be embodied in many alternative forms, and should not be construed as being limited to the exemplary embodiments set forth herein.

Accordingly, while exemplary embodiments of the disclosure are capable of being variously modified and taking alternative forms, embodiments thereof are shown by way of example in the drawings and will herein be described in detail. It should be understood, however, that there is no intent to limit the present disclosure to the particular exemplary embodiments disclosed. On the contrary, exemplary embodiments are to cover all modifications, equivalents, and alternatives falling within the scope of the disclosure.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements should be interpreted in a like fashion (e.g. “between” versus “directly between”, “adjacent” versus “directly adjacent”, etc.).

The terminology used herein is for the purpose of describing particular embodiments only and is not intended to be limiting of exemplary embodiments of the disclosure. As used herein, the singular forms are intended to include the plural forms as well, unless the context clearly indicates otherwise. It will be further understood that the term “include” or “have”, when used herein, specifies the presence of stated features, integers, steps, operations, elements, components, or combinations thereof, but do not preclude the presence or addition of one or more other features, integers, steps, operations, elements, components, or combinations thereof.

Unless otherwise defined, all terms used herein, which include technical or scientific terms, have the same meanings as those generally appreciated by those skilled in the art. The terms, such as ones defined in common dictionaries, should be interpreted as having the same meanings as terms in the context of pertinent technology, and should not be interpreted as having ideal or excessively formal meanings unless clearly defined in the specification.

Meanwhile, when a certain embodiment is capable of being realized in a different manner, functions or operations specified in a specific block may be executed in an order different from that shown in a flowchart. For example, two consecutive blocks may be executed simultaneously, or may be executed in the reverse order, depending on the related function or operation.

Hereinafter, a transformer and a power supply unit using the same according to the present disclosure will be described with reference to the accompanying drawings.

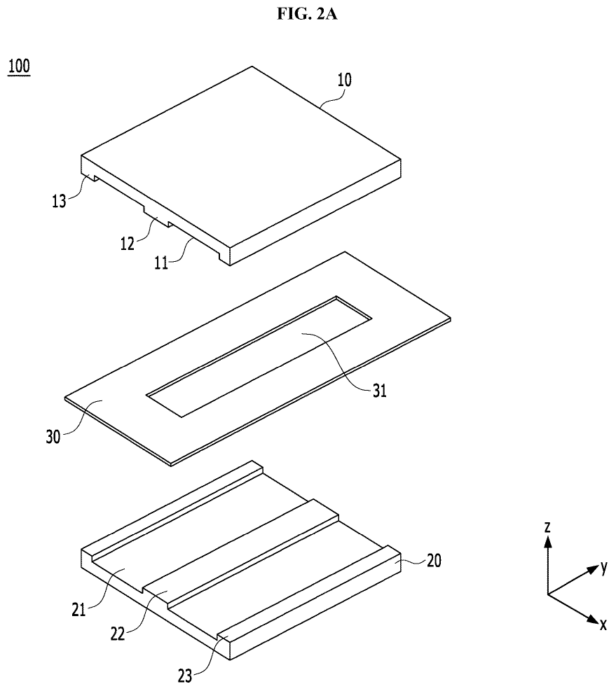

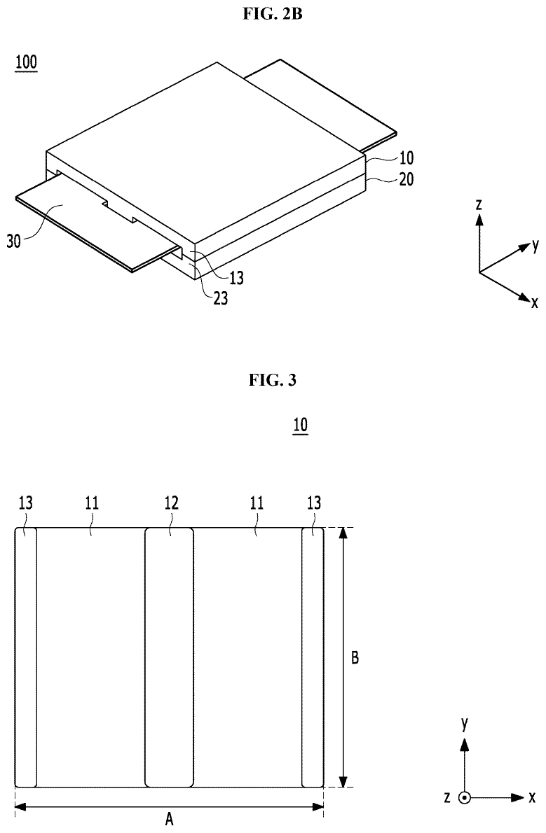

FIG. 2A is an exploded perspective view showing an example of the configuration of a slim transformer, and FIG. 2B is a perspective view of the slim transformer shown in FIG. 2A. Referring to FIG. 2A, the slim transformer 100 includes a core unit including an upper core 10 and a lower core 20 and a bobbin 30 configured to receive a primary coil (not shown) and a secondary coil (not shown) between the upper core 10 and the lower core 20. The core unit may include a magnetic material, for example, iron or ferrite, but the disclosure is not necessarily limited thereto.

The upper core 10 and the lower core 20 have the same shape and are disposed to face each other. The upper core 10 and the lower core 20 respectively include flat plate-shaped body portions 11 and 21 and include a plurality of legs formed by protruding portions protruding in a thickness direction from the body portions 11 and 21 and extending in one axial direction. The upper core 10 and the lower core 20 are combined such that center legs 12 and 22 thereof are inserted into a hollow portion 31 formed in the central portion of the bobbin 30, as shown in FIG. 2B.

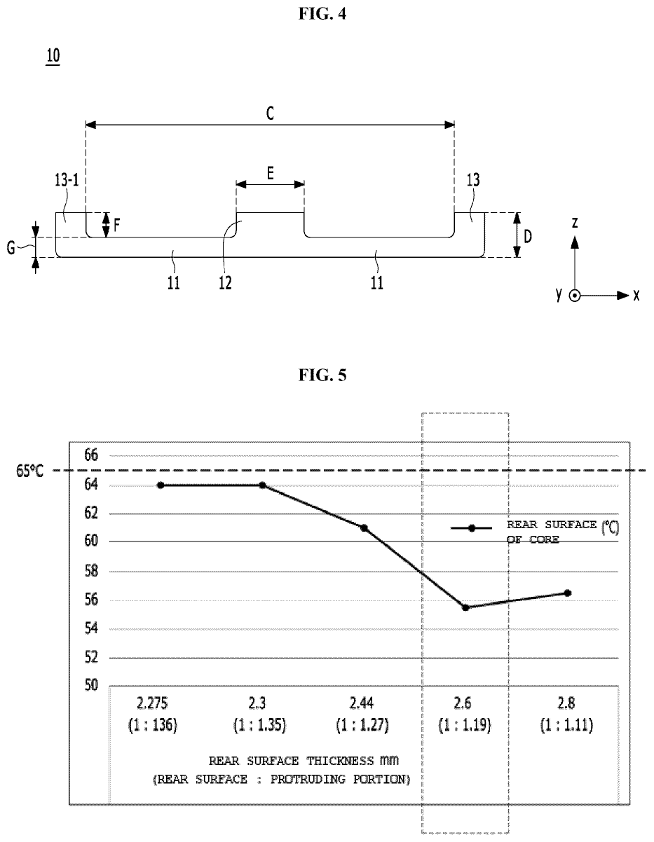

FIG. 3 is a plan view of the upper core of the transformer according to the present disclosure, and FIG. 4 is a front view of the upper core shown in FIG. 3. Hereinafter, the upper core will be described by way of example. However, as described above, the upper core and the lower core have the same shape and thus have the same technical features.

As shown in FIGS. 3 and 4, the upper core 10 includes a plurality of legs protruding in the thickness direction (z-axis direction) from the planar body portion 11 and extending in a y-axis direction. The plurality of legs includes two outer legs 13 disposed apart from each other at respective longitudinal ends of the body portion and one center leg 12 disposed between the two outer legs 13. In the upper core 10 and the lower core 20, the outer legs 13 and 23 corresponding to each other are disposed to face each other, and the center legs 12 and 22 corresponding to each other are disposed to face each other. A gap of a predetermined distance is formed between at least one pair among the opposing pairs of outer legs 13 and 23 and the opposing pair of center legs 12 and 22.

The area of the body portion 11 (in the x-axis direction) is denoted by “A”, and the length of the body portion 11 (in the y-axis direction) is denoted by “B”. In this case, the outer legs 13 and the center leg 12 have a length equal to “B”. The area of the center leg 12 is denoted by “E”.

The overall thickness of each of the outer legs 13 is the sum of the thickness of the body portion 11 and the thickness of a protruding portion 13-1 that protrudes from the body portion 11. As shown in FIG. 4, the overall thickness “D” of the outer leg 13 is the sum of the thickness “G” of the body portion 11 and the thickness “F” of the protruding portion 13-1. This relationship is expressed as D=G+F.

In the present disclosure, when the overall thickness of the transformer is 10.4 mm or less, it is advantageous that the ratio of the thickness G of the body portion 11 to the thickness F of the protruding portion 13-1 be equal to or less than 1:0.99. That is, it is advantageous that the thickness F of the protruding portion be equal to or less than 0.99 times the thickness G of the body portion, such as F≤0.99G. In this case, it is advantageous that the thickness G of the body portion 11 be equal to or greater than 25% of the overall thickness (D^{×}2) of the transformer, such as G≥0.25(D^{×}2).

On the other hand, in the present disclosure, when the overall thickness of the transformer is greater than 10.4 mm, it is advantageous that the ratio of the thickness G of the body portion 11 to the thickness F of the protruding portion 13-1 be equal to or greater than 1:1.01. That is, it is advantageous that the thickness F of the protruding portion be equal to or greater than 1.01 times the thickness G of the body portion, such as F≥1.01G. In this case, it is advantageous that the thickness G of the body portion 11 be equal to or greater than 18% and less than 25% of the overall thickness (D^{×}2) of the transformer, such as 0.18(D^{×}2)≤G<0.25(D^{×}2).

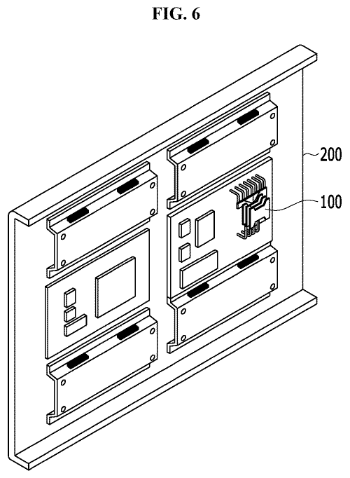

FIG. 5 is a graph showing heat generation of the core according to the thickness of the rear surface during operation of the transformer. In detail, the graph shows the results of measuring the temperature resulting from heat generated from the rear surface of the core after operating the transformer for 30 minutes. In this case, the rear surface refers to the body portion of each of the upper core and the lower core.

As shown in the graph, it may be seen that the temperature resulting from heat generation is lowest, approximately 55 °C, when the thickness of the rear surface is 2.6.

Because the advantageous ratio of the thickness of the rear surface to the thickness of the protruding portion is equal to or less than 1:0.99 when a transformer having an overall thickness of 10.4 mm or less is designed, if the thickness of the rear surface is, for example, 2.6 mm, the thickness of the protruding portion may be 2.574 mm or less. Accordingly, each of the upper core and the lower core may have a thickness of 5.174 mm or less, and thus the overall thickness of the transformer, in which the upper core and the lower core are combined, may be 10.348 mm or less.

On the other hand, because the advantageous ratio of the thickness of the rear surface to the thickness of the protruding portion is equal to or greater than 1:1.01 when a transformer having an overall thickness greater than 10.4 mm is designed, if the thickness of the rear surface is, for example, 2.6 mm, the thickness of the protruding portion may be 2.626 mm or greater. Accordingly, each of the upper core and the lower core may have a thickness of 5.226 mm or greater, and thus the overall thickness of the transformer, in which the upper core and the lower core are combined, may be greater than 10.452 mm.

The transformer 100 designed as described above may be mounted on a substrate 200 to form a power supply unit, as shown in FIG. 6.

As described above, when a transformer having a thickness of 10.4 mm or less is designed and when a transformer having a thickness greater than 10.4 mm is designed, the thicknesses of the rear surface and the protruding portion of each of the upper core and the lower core may be designed in an optimal ratio, thereby preventing warpage of the core during a curing process after bonding as well as during operation.

Although the exemplary embodiments of the present disclosure have been disclosed for illustrative purposes, those skilled in the art will appreciate that various modifications, additions and substitutions are possible, without departing from the scope and spirit of the disclosure as disclosed in the accompanying claims.

### INDUSTRIAL APPLICABILITY

The transformer and the power supply unit using the same according to the present disclosure may be applied to display devices.

1. A transformer, comprising:
a core unit including an upper core and a lower core disposed to face each other and configured to be combined with each other; and
a bobbin at least partially disposed between the upper core and the lower core,
wherein each of the upper core and the lower core includes:
a flat plate-shaped body portion; and
a plurality of legs, each being formed by a protruding portion protruding in a thickness direction from the body portion and extending in one axial direction, and
wherein the protruding portion has a thickness different from a thickness of the body portion.

2. The transformer according to claim 1, wherein the thickness of the protruding portion is equal to or less than 0.99 times the thickness of the body portion.

3. The transformer according to claim 2, wherein the thickness of the body portion is equal to or greater than 25% of an overall thickness of the transformer.

4. The transformer according to claim 3, wherein the overall thickness of the transformer is equal to or less than 10.4 mm.

5. The transformer according to claim 4, wherein the thickness of the body portion is in a range of 2.5 mm to 2.7 mm.

6. The transformer according to claim 1, wherein the thickness of the protruding portion is equal to or greater than 1.01 times the thickness of the body portion.

7. The transformer according to claim 6, wherein the thickness of the body portion is equal to or greater than 18% and less than 25% of an overall thickness of the transformer.

8. The transformer according to claim 7, wherein the overall thickness of the transformer is greater than 10.4 mm.

9. The transformer according to claim 1, wherein the plurality of legs includes:
two outer legs disposed apart from each other at respective longitudinal ends of the body portion; and
a center leg disposed between the two outer legs.

10. The transformer according to claim 9,
wherein the outer legs corresponding to each other of the upper core and the lower core are disposed to face each other,
wherein the center legs corresponding to each other of the upper core and the lower core are disposed to face each other, and
wherein a gap of a predetermined distance is formed between at least one pair among the opposing pairs of outer legs and the opposing pair of center legs.

11. The transformer according to claim 4, wherein the thickness of the body portion is 2.6 mm, and
wherein the thickness of the protruding portion is 2.574 mm or less.

12. The transformer according to claim 8, wherein the thickness of the body portion is 2.6 mm, and
wherein the thickness of the protruding portion is 2.626 mm or greater.

13. The transformer according to claim 9, wherein an overall thickness of the transformer is a two times sum of the thickness of the body portion and the thickness of a protruding portion.

14. A transformer, comprising:
a core unit including an upper core and a lower core disposed to face each other in a first direction; and
a bobbin at least partially disposed between the upper core and the lower core,
wherein each of the upper core and the lower core includes:
a body portion having a first thickness in the first direction; and
a protruding portion protruding in the first direction from the body portion and having a second thickness in the first direction,
wherein the protruding portion includes:
two outer legs disposed apart from each other at respective longitudinal ends of the body portion; and
a center leg disposed between the two outer legs, and
wherein a ratio of the first thickness to the second thickness is determined according as an overall thickness corresponding to two times sum of the first thickness and the second thickness is equal to, less than, or greater than 10.4 mm.

15. The transformer according to claim 14, wherein in case that the overall thickness is 10.4 mm or less, the ratio of the first thickness to the second thickness is equal to or less than 1:0.99.

16. The transformer according to claim 15, wherein the first thickness is equal to or greater than 25% of the overall thickness.

17. The transformer according to claim 14, wherein in case that the overall thickness is greater than 10.4 mm, the ratio of the first thickness to the second thickness is equal to or greater than 1:1.01.

18. The transformer according to claim 17, wherein the first thickness is equal to or greater than 18% and less than 25% of the overall thickness.

19. The transformer according to claim 14, wherein the first thickness is 2.6 mm.

20. A power supply unit, comprising:
the transformer according to claim 1; and
a substrate having the transformer mounted thereon.
